(19) United States
(12) Patent Application Publication
(10) Pub. No.: US 2024/0284835 A1
(43) Pub. Date: Aug. 29, 2024

(54) INFLATABLE GREENHOUSE STRUCTURE

(71) Applicant: Herbert E. Ankrom, JR., Salt Lake City, UT (US)

(72) Inventor: Herbert E. Ankrom, JR., Salt Lake City, UT (US)

(21) Appl. No.: 18/113,324

(22) Filed: Feb. 23, 2023

(51) Int. Cl. A01G 9/14; A01G 9/16

(52) U.S. Cl. CPC A01G 9/1407; A01G 9/16

(57) ABSTRACT

An inflatable greenhouse formed from elements constructed of inflatable compartments which is entirely self-supporting when inflated is disclosed. The greenhouse has a double-walled structure of flexible sheet material which gives the greenhouse structural rigidity when inflated and which increases the thermal protection provided by the greenhouse. The walls of the greenhouse are made of a transparent or translucent plastic material to allow optimal light transmission for photosynthetic plants or of a light filtering or opaque plastic material for light-sensitive plants and animals. The greenhouse has an access door through the wall to allow easy access to the interior of the structure. The inflatable greenhouse has a foundation which is separately inflatable with a fluid, such as water, for stabilizing and anchoring the greenhouse against movement by wind or storms.

### RELATED APPLICATION

This application claims the benefit under 35 U.S.C. § 119 of Provisional Application No. 63/312,865 entitled AN INFLATABLE GREENHOUSE STRUCTURE, filed 23 Feb. 2022. The aforesaid provisional patent application is hereby incorporated by reference in its entirety.

### FIELD OF THE INVENTION

The present invention relates generally to a building structure fabricated from flexible, inflated membranes. More particularly, the invention is directed to a greenhouse fabricated from such membranes for use in germinating, cultivating and protecting plants or animals.

### BACKGROUND OF THE INVENTION

Horticultural greenhouses have long been utilized by gardeners to facilitate the growing of plants. Such greenhouses have proven especially beneficial during winter months when environmental conditions make the germination and cultivation of plants outdoors difficult, if not impossible. Historically greenhouses have taken the form of a steel or wood framed building with the walls and roof of such a building constructed from panes of glass secured within a series of interconnected frame-like elements. The panes of glass permit ambient sunlight to pass through the walls and roof of the greenhouse to aid in plant development while simultaneously maintaining a temperature and humidity within the greenhouse which adequately supports plant growth. Such greenhouses tend to be expensive to build and maintain and are generally, once constructed, permanently installed in place. Not only are such greenhouses beyond the affordability of the average homeowner, but furthermore, the permanence of such structures severely limits the homeowner's ability to enjoy the rather oftentimes spatially restricted area of his/her backyard during times when the greenhouse is not being used, e.g. the Spring and Summer months in particular.

There exists a need for greenhouse structures which may be readily constructed within a homeowner's backyard for use during the winter months and which may subsequently may be disassembled and stored during those months in which the homeowner can cultivate plants outdoors without the protections afforded by a greenhouse.

Various attempts have been made in the past to address the problems identified by the instant invention. For example, U.S. Pat. No. 4,164,829, directed to an INFLATABLE STRUCTURE, illustrates an inflatable dome-shaped structure. This particular structure relies on an elevated internal air pressure for structural support. Notably, this structure would seemingly require a constant supply of pressurized air into its interior if that interior is to be ventilated, as would normally be required if that interior were to support plant growth. U.S. Pat. No. 4,876,829 for an INFLATABLE TENT STRUCTURE relates to a dome-shaped tent which utilizes a plurality of inflatable tubes. U.S. Pat. No. 5,007,212 relates to an INFLATABLE SHELTER for use as a camping tent.

U.S. Pat. No. 4,807,405 entitled GEODESIC INFLATABLE STRUCTURE AND METHODS OF UTILIZING SAME describes a complex dome-shaped structure which utilizes a support framework configured in the shape of a lattice. The lattice, constructed from inflatable tubular ribs is supplemented with a series of triangular inflatable panels positioned between the ribs of the framework. U.S. Pat. No. 4,384,435 for an INFLATABLE TENT discloses an inflatable hemispherical tent having multiple inflatable compartments. A manifold interconnects these various compartments at the top of the tent. The tent involves a complex array of welding seals which inevitably cause this tent to be expensive to produce and maintain. U.S. Pat. No. 4,583,330 entitled a MODULAR INFLATABLE DOME STRUCTURE illustrates a dome-shaped structure having a modular support framework. This particular structure, due to its use of a vulcanization process during its manufacturing process, is anticipated to be a permanent structure ill-suited for disassembly after its use during the winter season.

In addition to the aforementioned structures, a number of inflatable structures, specifically designed for use as greenhouses are also known. For example: U.S. Pat. No. 4,027,437 for an INFLATABLE BUILDING discloses an inflatable structure which is adapted for use as a greenhouse. Not being self-supporting, the structure requires a separate rigid framework for supporting the inflatable tubes which constitute the structure's walls. U.S. Pat. No. 5,433,030 entitled a PLANT PROTECTOR suggests a cylindrical inflatable greenhouse. for plants with a doorway through the cylindrical wall. Constructed of a number of interconnected horizontal rings, the walls of the inflatable cylindrical structure are formed by use of long welded seams.

The known inflatable structures do not appear to provide a greenhouse structure which utilizes an inflated frame support structure which is inexpensive to manufacture, which is suitably held in place by a ballast type reservoir and which furthermore provides sufficient light transmission, thermal protection, ventilation and interior access to make it suitable for use as a temporary greenhouse structure.

### SUMMARY OF THE INVENTION

In keeping with the foregoing discussion, the present invention provides an inflatable structure which is suitable for use as a portable or temporary greenhouse for cultivating and protecting plants or animals. In one aspect of the invention, in order to make the inflatable structure suitable for use as a greenhouse for photosynthetic plants, the walls of the structure are transparent or translucent to allow sufficient light transmission at the wavelengths necessary for plant growth. In an alternate aspect of the invention, the walls of the inflatable structure can be made of a light filtering or opaque material for growing light-sensitive plants and animals, such as mushrooms or escargot. Another aspect of the invention is that the structure must provide sufficient thermal protection for the plants housed therein.

In a further aspect the structure is adapted to allow sufficient ventilation for temperature control and for circulating oxygen and carbon dioxide in adequate amounts to the plants within the structure. A fourth aspect is that the interior of the structure must be readily accessible for cultivating the plants or animals within the greenhouse. A fifth aspect is that the structure must be sufficiently stable and stationary to protect the plants enclosed without collapsing or blowing away in the event of strong winds or violent storms.

It is another objective of the invention to provide an inflatable structure which is inexpensive to produce so that it can be priced to be accessible to homeowners and casual gardeners and not just to professionals. To accomplish this, the inflatable structure should be configured to be produced using simple manufacturing techniques and wherever possible to avoid costly manufacturing steps.

In a further aspect of the invention an inflatable structure is configured to be entirely self-supporting and therefore does not require any rigid framework or supporting members.

In order to fulfill these aspects, the present invention takes the form of an inflatable greenhouse which is entirely self-supporting when inflated. The greenhouse may have a double-walled structure which gives the greenhouse structural rigidity when inflated and which increases the thermal protection provided by the greenhouse. The walls of the greenhouse are made of a transparent or translucent flexible material, such as plastic, to allow optimal light transmission for photosynthetic plants or of a light filtering or opaque plastic material for light-sensitive plants and animals. The greenhouse has an access door through the wall to allow easy access to the interior of the structure. The door is placed such that it does not interrupt the structural integrity of the inflated structure, therefore no rigid structural members are needed to support the walls. In another aspect the walls of the structure are supported by a frame construction fabricated from drop stitch fabric secured to a sheet of transparent fabric. When the drop stitch fabric is inflated it produces a generally rigid frame which supports the transparent fabric.

The inflatable greenhouse has a lower foundation which is separately inflatable with a dense medium, such as water, for stabilizing and anchoring the greenhouse against movement by wind or storms.

The inflatable greenhouse is designed for low cost manufacturing. The double walled structure of the greenhouse can be formed of two sheets of flexible material such as plastic. The inner and outer walls of the structure are coupled together at numerous points in a pattern which lends to the structural rigidity of the greenhouse when inflated. In a particularly preferred embodiment of the invention, the two sheets of material are secured together to form a plurality of elongate, inflatable compartments which are conjoined to one another to form a structure, which when inflated, exhibits structural rigidity. This use of inflatable compartments not only provides the structural rigidity required of an inflatable greenhouse, but moreover, results in a greenhouse construction which may be cost effectively manufactured. Inasmuch as possible, long linear or curved seams which would add to the manufacturing cost of the greenhouse are avoided.

The inflatable greenhouse has an air inflation fitting connected to the double-walled structure and a water inflation fitting connected to the lower foundation. Preferable, a pressure relief valve may also be connected to the double-walled structure in the vicinity of the air inflation fitting to protect the structure from over inflation. Another pressure relief valve may be connected to the lower foundation in the vicinity of the water inflation fitting to protect the lower foundation from over inflation.

### BRIEF DESCRIPTION OF THE DRAWINGS

FIG. 1 is a front elevational view of the inflatable greenhouse of the present invention;

FIG. 2 is an exploded elevational view of the inflatable greenhouse of FIG. 1;

FIG. 3 is a front elevational view of the frame structure of the inflatable greenhouse shown in association with the lower foundation ring;

FIG. 4 is an elevational view of the frame structure of the inflatable greenhouse showing the upright walls of the greenhouse being installed over the upright wall frame of the greenhouse;

FIG. 5 is an elevational view of the frame structure of the inflatable greenhouse illustrating the right walls in association with a series of sealing strips which interconnect adjacent upright wall panels;

FIG. 6 is a sectional perspective view of an upright wall panel of the greenhouse;

FIG. 7 is an another sectional perspective view of an alternative upright wall panel of the greenhouse, shown in association with an air pump, which is utilized to inflate either the wall panels or the foundation ring;

FIG. 8 is a cross sectional view of an upright wall element illustrating the bayonet flange positioned on the lower end of the wall panel;

FIG. 9 is a perspective, cross sectional view of the lower foundation ring of the greenhouse, illustrating a slot configured to receive and retain the bayonet flange of the upright sidewall of the green house;

FIG. 10 is a sectional view of a ground engaging flange of the lower foundation ring of the greenhouse;

FIG. 11 is a cross sectional view of the lower foundation ring of the greenhouse showing the slot together with an inlet and outlet port. The view further illustrates the ground engaging floor of the foundation ring engaging a plurality of stones resident on the upper surface of the ground;

FIG. 12 is a vertical sectional view of an upright wall of the greenhouse;

FIG. 13 is a cross sectional view of the lower foundation ring showing the slot in greater detail;

FIG. 14 is an exploded perspective, sectional view of the wall element and foundation ring engagement;

FIG. 15 is a perspective, sectional view of a wall element engaging the lower foundation ring;

FIG. 16 is a perspective elevational view of a second embodiment of the inflatable greenhouse of the invention;

FIG. 17 is a sectional view of interior of the greenhouse of FIG. 16;

FIG. 18 is a sectional view of interior of the greenhouse of FIG. 16 wherein the wall of the greenhouse has been fitted with a plurality of shelves;

FIG. 19 is a perspective view of a rolled section of a wall element of the greenhouse of FIG. 16;

FIG. 20 is a perspective view of the wall element of FIG. 19 wherein the section of wall element has been partially unrolled; and

FIG. 21 is a perspective view of the wall element of FIG. 20 being positioned atop a sheet of wall material.

### DETAILED DESCRIPTION OF THE INVENTION

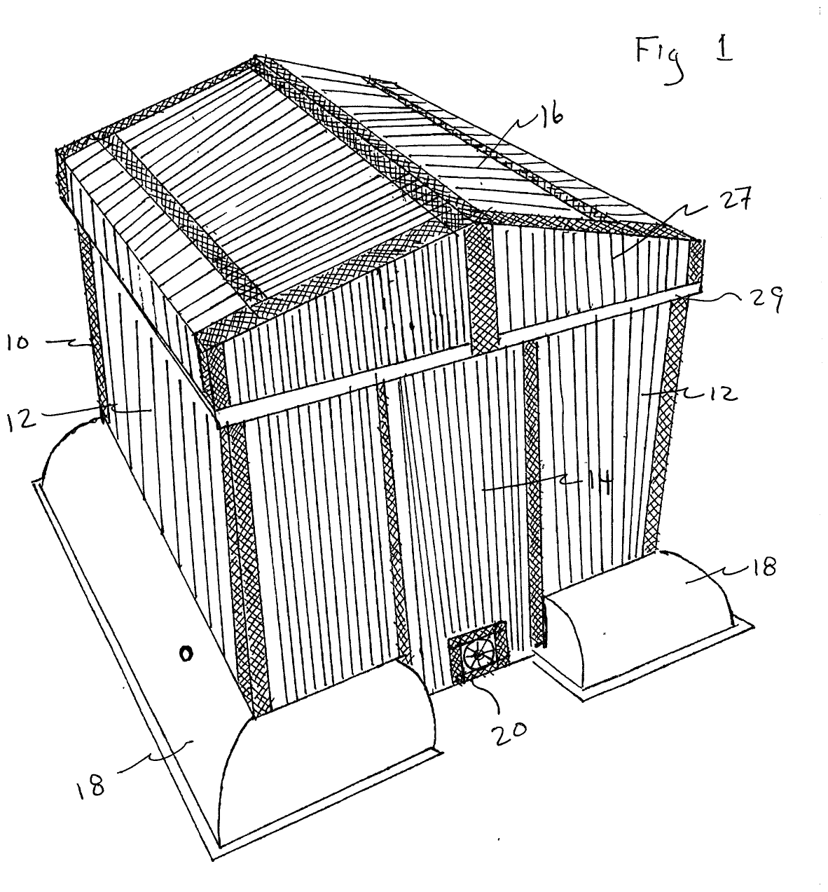

The inflatable greenhouse 10 of the present invention is shown to advantage in the front elevational view of FIG. 1. As shown the greenhouse 10 includes a series of upright wall elements 12, fitted with a vertically positioned door 14. A roof element 16 is positioned on the upper ends of the wall elements 12. The lower ends of the upright wall elements 12 are secured within a flexible ballast foundation 18 which extends generally about the perimeter of the greenhouse 10. A fan fitted ventilation opening 20 is also shown positioned within the door 14. In alternative aspects of the invention the ventilation opening 20 may be located at various locations within the upright wall elements 12 and/or within the roof element.

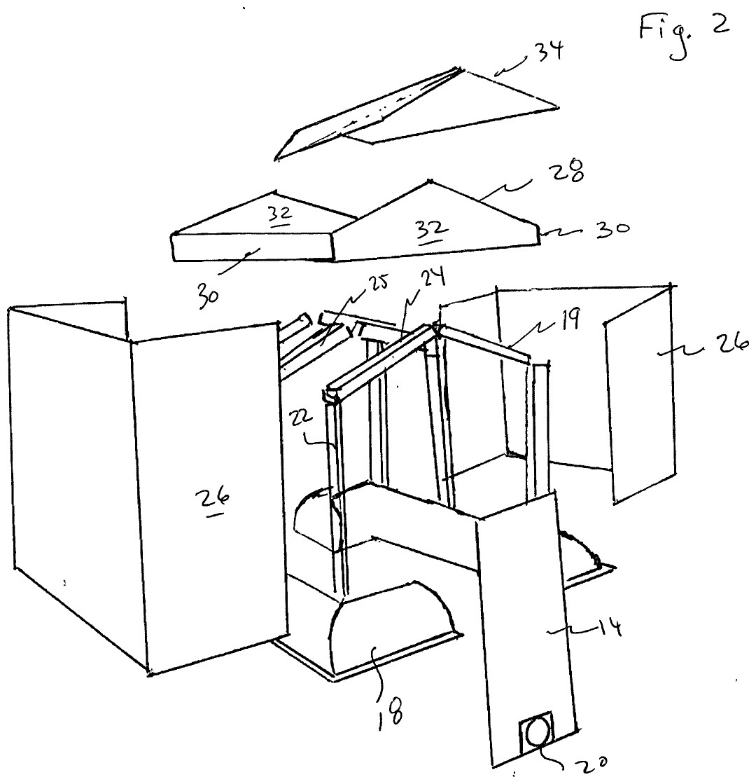

FIG. 2 illustrates the frame 19 of the greenhouse in association with the wall frame elements 26, the roof lower structure 28 and the upper roof element 34. As shown the greenhouse frame 19 includes a plurality of upright wall frame elements 22 which are spacedly positioned about the perimeter of the greenhouse to extend from the foundation 18 vertically upward to an engagement with a plurality of roof rafters 24. As shown each wall element 22 engages a respective rafter 25 with each wall element 22, positioned at the corner of the greenhouse engaging with a respective rake element 24. Generally speaking, each wall element 22 may be formed of plastic or other flexible material, Each wall element defines a series of air filled segments or cells within the interior thereof which are filled with pressurized air to provide rigidity to the elements. The construction of the wall elements will be described in more detail later in this description. The wall elements 22 are formed into two distinct sets, with each set of wall elements being positioned spacedly along a respective side of the green house. Essentially the two sets of wall elements 22 are positioned opposite one another about a horizontal axis 27. As shown each wall element of the first set of wall elements is positioned opposite a counterpart wall element 22 of the second set of wall elements.

Each frame element 22 is fitted at its lower end 55 with a flange or extension 46. As shown in FIG. 8, this flange 46 may be constructed by the wall element 52 being folded back on itself to form a double thickness of the material constituting the wall element 52. Once the material forming wall element 52 has defined the flange 46, it is folded to extend outward to form the secondary bottom edge 55 of the frame element 22. The flange 46 is dimensioned to be inserted into and retained by a slot 46 defined within the body of foundation 18.

The roof rafters 25 and the rakes 24 are constructed similarly to the upright wall elements and are therefore constructed of generally rigid members, which while being translucent or transparent to allow light to enter the interior of the greenhouse from the environment, also provide structural integrity to the greenhouse by supporting not only the walls 26 of the greenhouse but also its roof structure 16. As shown, a first end of each rafter 25 and rake 24 is secured to the upper end of a respective wall element 22. This securement may be accomplished through adhesives, mechanical fittings or other means which are well known in the art. A second end of each rafter and rake is secured to the second end of an oppositely positioned counterpart rafter 25 or rake 24. Each oppositely positioned rafter 25 or rake 24, in turn, is secured on its first end to the upper end of a respective wall element 22 which extends from a counterpart wall element 22. In alternate constructions, a horizontally oriented ridge board may be positioned between the second ends of the rafters to provide further rigidity to the roof construction.

In one aspect of the invention the roof of the greenhouse may be formed of two distinct elements, namely a lower roof section 28 and an upper roof section 34. As shown the lower roof section 28 includes a pair of gables 32 which are positioned spacedly from one another and generally parallel to one another. The number of gables in the roof may be varied responsive to the structural requirements of the greenhouse. Moreover, the gables may be fabricated of a drop stitch fabric of some other inflatable compartment defining material of the type utilized to construct the other structural elements of the green house. The gables are generally triangular in shape. The two gables are connected to one another by a pair of facia elements 30. A first end of a fascia element 30 is secured to a first gable 32 while an opposing second end of the fascia element is secured to the second gable 32. The association of the two gables 32 and the two fascia elements 30 form a generally quadrilateral shaped structure which is dimensioned to sit atop the rafters 25 and rakes 25.

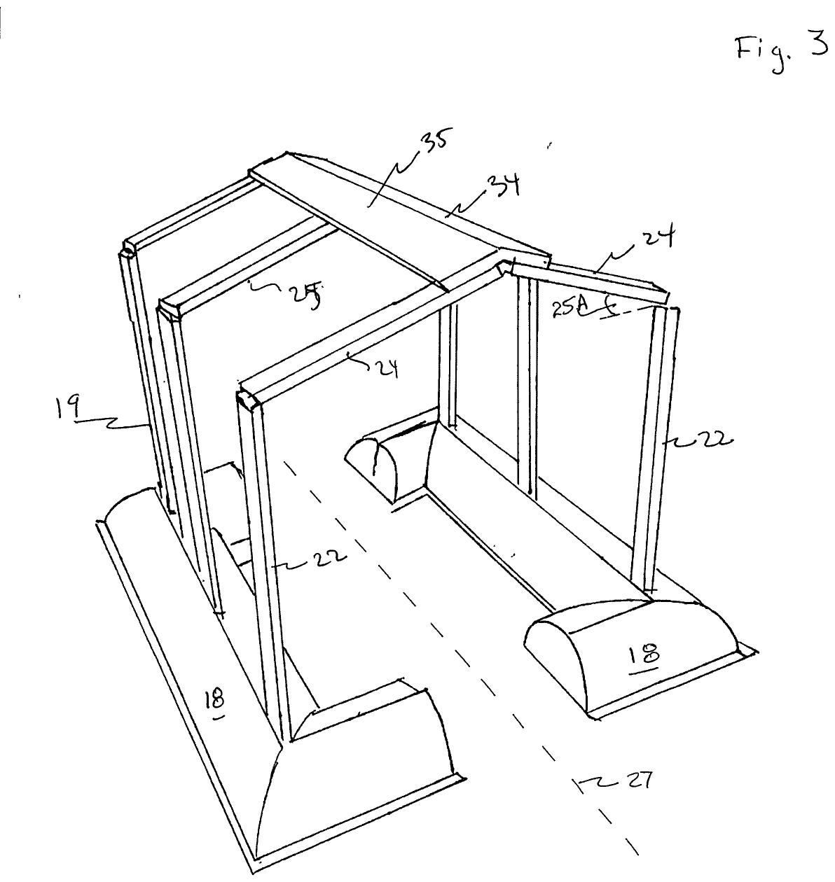

Positioned on the upper edges of the gables 32 and fascia elements 30 is the upper roof section 34. The upper roof section 34 is essentially the roof sheathing for the greenhouse and may be formed of a series of horizontally oriented rigid roof elements 35, which are similar in construction to the wall elements 22 or the rafters 25 or rakes 24. As shown in FIG. 3 the roof elements may also be secured to the rafters 25 and the rakes 24 to form a generally rigid frame structure 19 for the greenhouse 10.

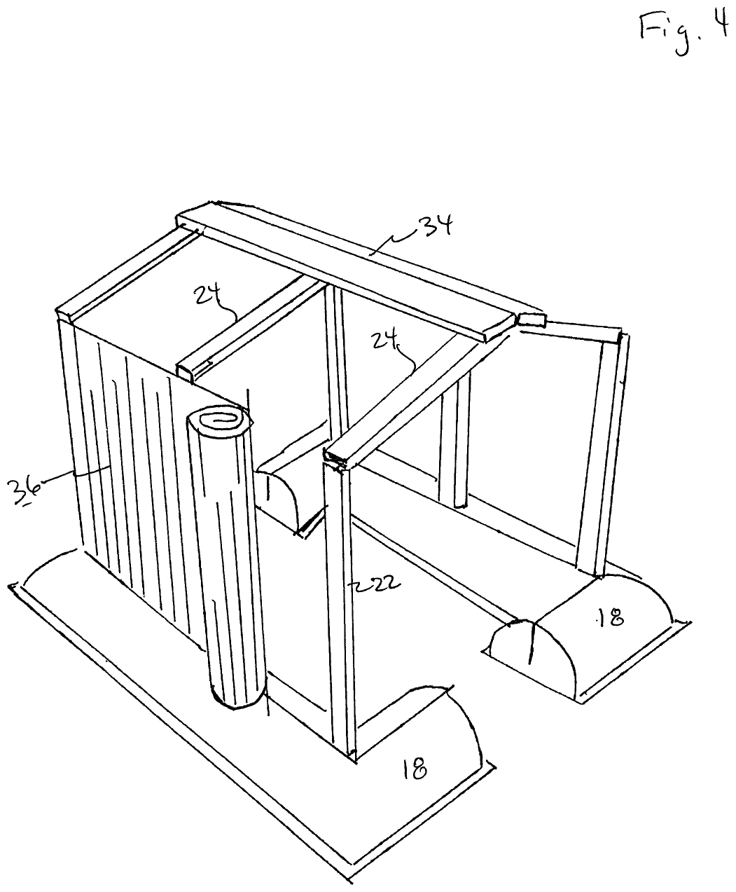

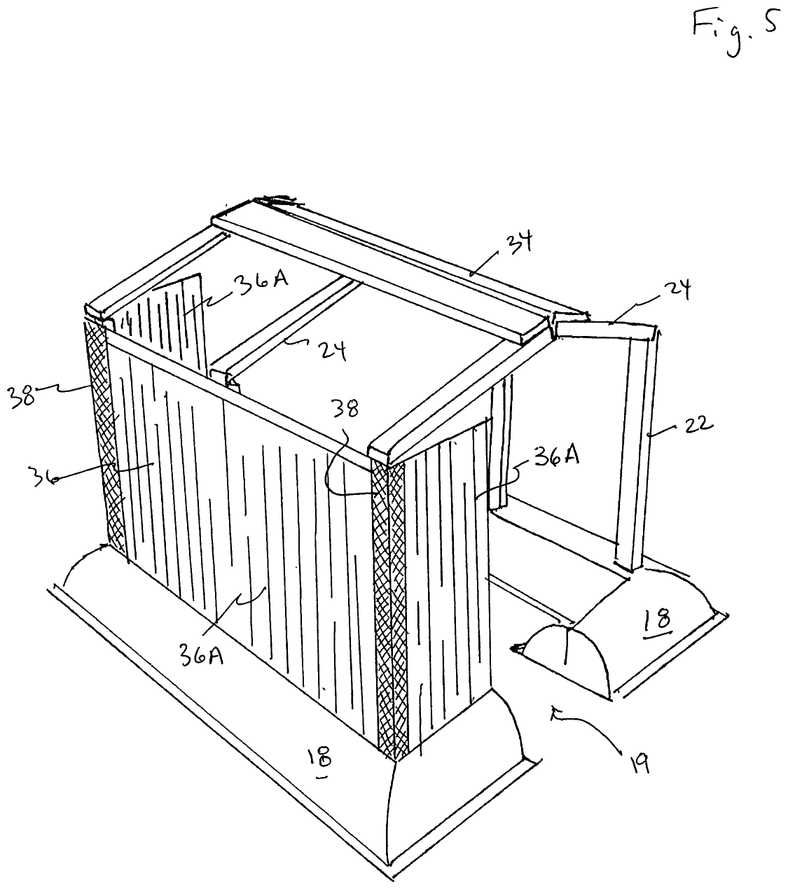

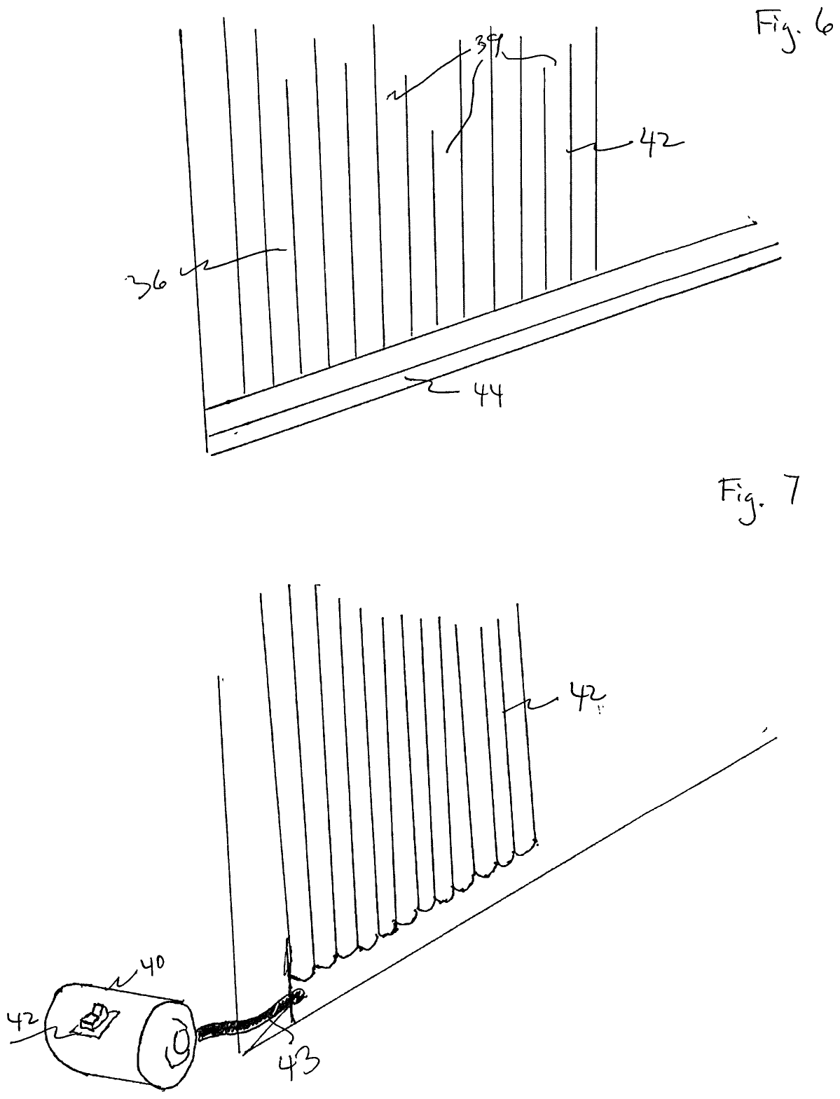

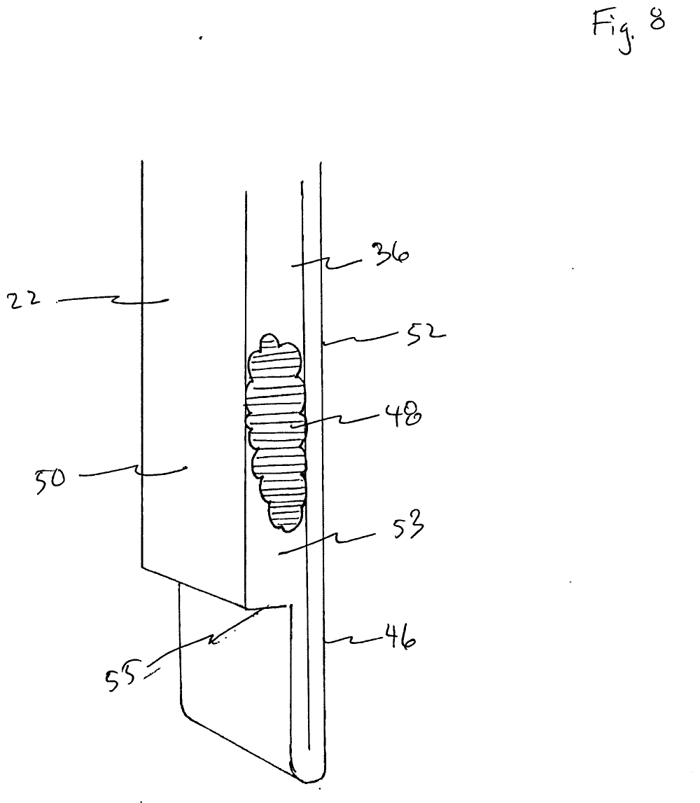

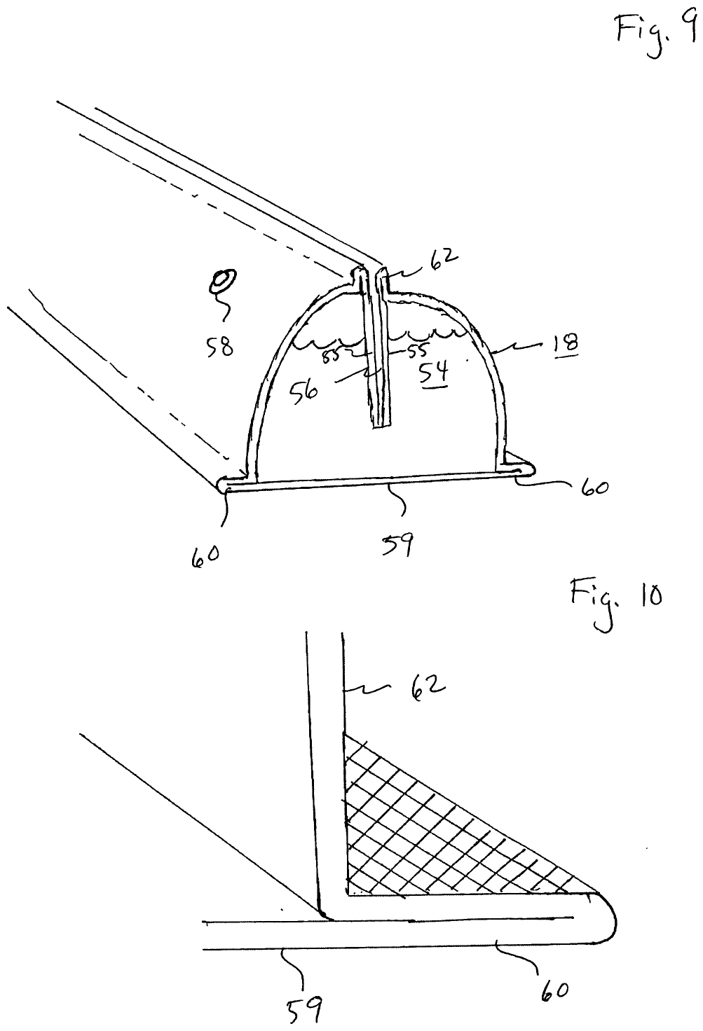

Wall panels 26, shown in FIG. 2, are configured to be secured to the upright wall elements 22 as well as the gables 32 and fascia 30 to generally enclose the interior of the greenhouse. FIG. 2 illustrates wall panel constructions 26 which are sufficiently rigid to be generally self-standing. In alternative aspects of the invention, such as that shown in FIG. 4 the wall panels 26 may be more flexible in construction, which flexibility permits the wall panels 26 to be formed by rolling sheets of semi-rigid material about the perimeter of the greenhouse frame 19 and thereafter securing the wall panels 26 to the upright wall elements 22. In this latter construction, the rigidity of the wall elements 22 provides the major portion of the structural rigidity for the greenhouse, while the construction shown in FIG. 2 relies more on the rigidity of the wall panels 26 to contribute to that rigidity. The construction of the wall panels 26 will be more discussed in more detail later in this description.

As shown to advantage in FIG. 3, the wall elements 22 are each secured to a lower foundation ring 18. In the aspect illustrated in FIG. 3 the foundation ring 18 is formed of two distinct oppositely positioned segments and may adopt several configurations. Each of these segments has a generally semi-circular cross-section with the linear portion of that cross section being oriented toward the ground surface underlying the greenhouse and the convex portion of that cross section being direct upward away from the ground surface. The foundation ring defines a connection structure for securing the wall elements to the foundation ring 18.

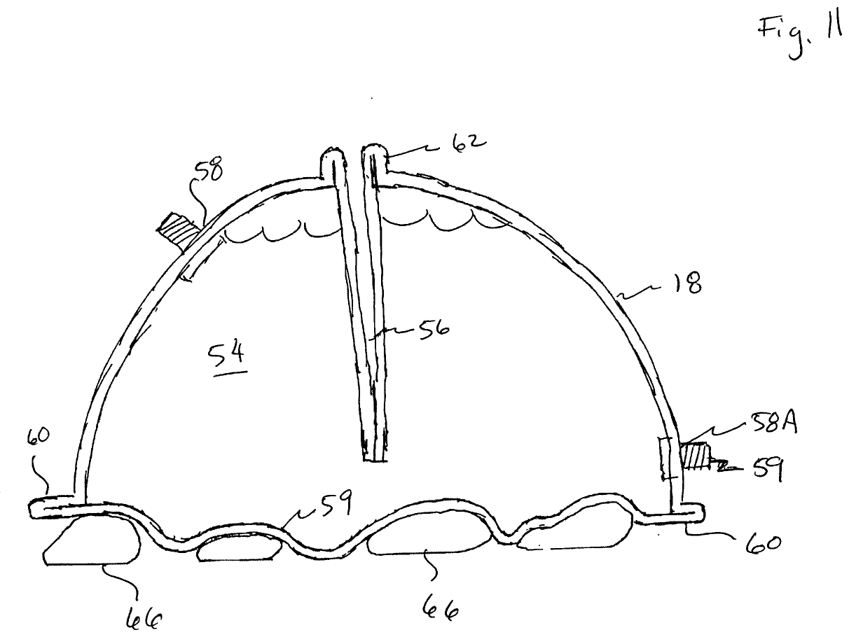

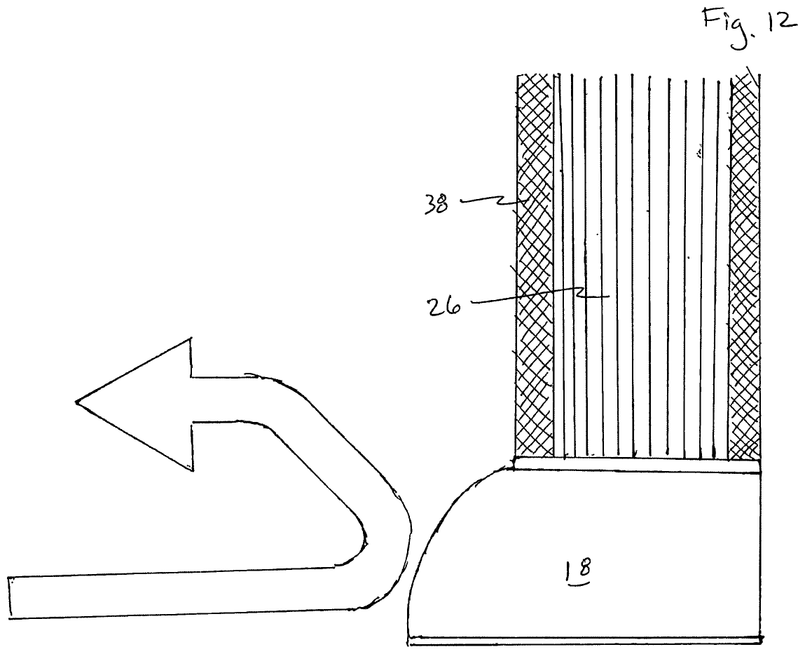

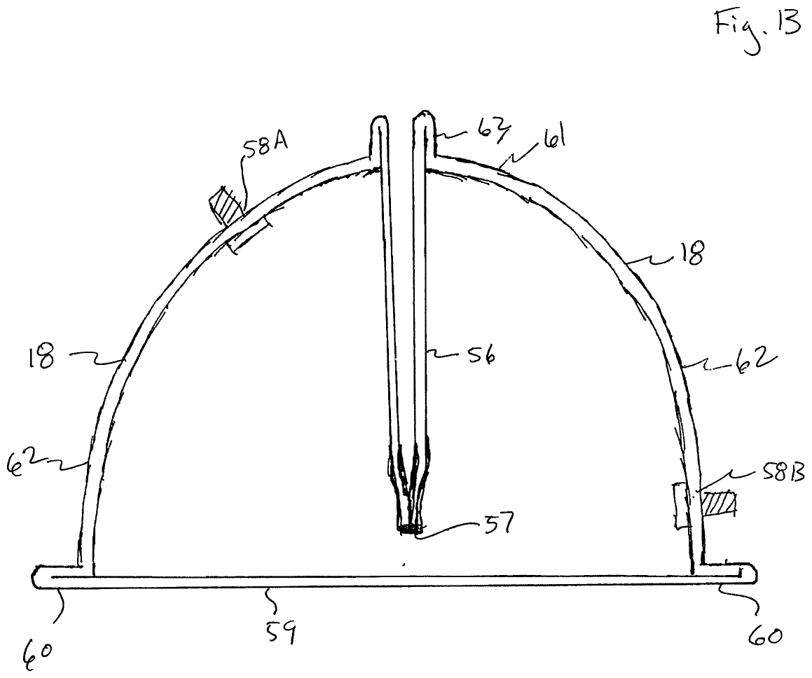

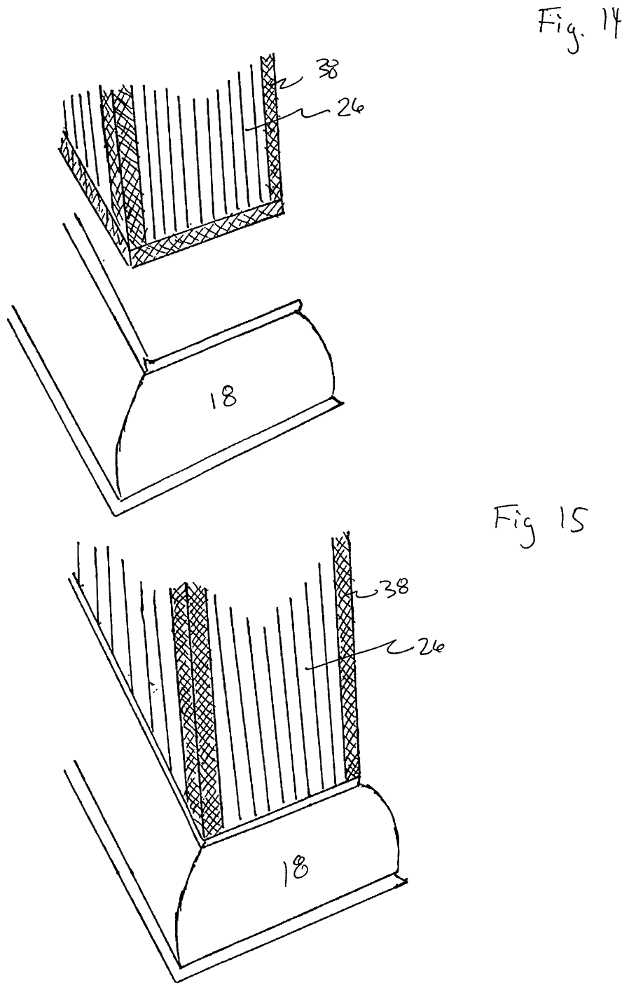

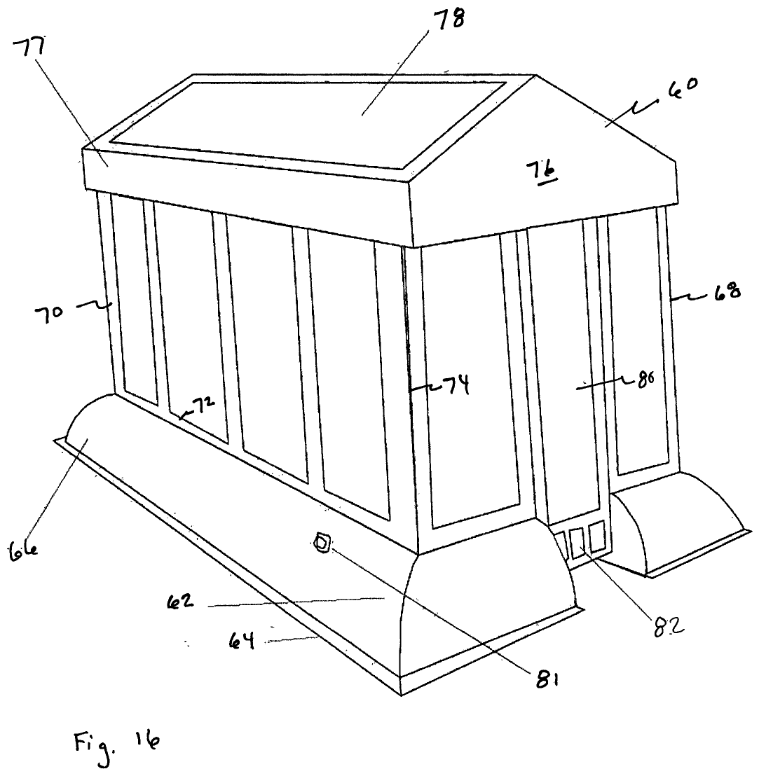

The construction of the foundation 18 is illustrated in greater detail in FIGS. 9-11 and 13. As shown the foundation 18 is an elongate structure which defines a generally semi-circular cross sectioned hollow interior. The foundation 18 includes a planar bottom surface 59, which being fabricated from a flexible material is adapted to deform over rocks and other objects located on the underlying ground surface as shown in FIG. 11. The ability of the bottom surface 59 to deform over these stones and objects is important in that it permits the foundation 18 to adapt to the underlying ground surface while permitting the top 61 of the foundation 18 to remain generally undisturbed by the irregularities of the underlying ground surface. This in turn permits a slot 56 defined in the top of the foundation to provide a generally flat surface which extends parallel to the underlying ground surface and provides a flat surface to which the wall elements of the greenhouse may be secured.

The outer edges of the bottom 59 of the foundation 18 define ears or flanges 60 which project outwardly from the body of the foundation 18. These ears are formed by the material of the foundation being folded back onto itself to form a double layer of material. These double layer ears operate to stabilize the foundation against being rotated about its laterally extending axis.

Extending upwards from the ears 60, the wall 62 of the foundation 18 defines a generally semi-circular cross sectioned enclosure. An inlet port 58A, with a threaded plug is shown positioned in the enclosure sidewall. The inlet port 58 provides a means whereby the user may introduce a quantity of fluid, e.g. water into the hollow interior of the foundation 18. Similarly an outlet port 588, having a threaded plug, is also shown. The outlet port 58B provides a means to drain the fluid resident within the interior of the foundation. 18.

At the top of the foundation 18, the walls 62 of the foundation are doubled back on themselves to form a pair of opposing flanges or extensions 63. By doubling back on themselves, the walls cause the flanges to have a certain measure of rigidity which extends laterally along the length of the foundation. Furthermore, the pair of rigid flanges provides a strong support for receiving and retaining the flange 46 of a wall element which is inserted between the two opposing flanges 63. The portions 55 of the flanges 63 which extend into the hollow interior of the foundation, are positioned generally parallel to one another to define a slot dimensioned to securely receive and retain the flange 46 of a wall frame element. As the flanges 63 reach their free ends, the distance between the two portions 55 decreases as the ends of the portions 55 are secured to one another at their respective ends. With the foundation being fabricated from a flexible resilient material, the flanges 63 are biased against the flange 46 as it is inserted into the slot 56 and thereby form a secure yet releasable coupling with the flange 46.

FIG. 4 illustrates the construction of the wall elements of the greenhouse. As shown a wall element 36, fabricated from a flexible material such as plastic is oriented vertically, secured along a free end thereof and then rolled over the frame elements 22 to define an upright wall for the greenhouse. The wall element is secured to each of the upstanding frame elements 22 to retain the wall element in place as well as to provide further rigidity to the upright wall construction. The wall element 36 is wrapped about the entire perimeter of the frame construction to provide an upstanding wall which substantially completely encloses the greenhouse defined by the frame elements 22.

FIG. 5 discloses an aspect of the wall construction wherein the wall element is formed of a number of separate wall element panels 36, with adjoining positioned wall elements 36 being secured to each other along their upright free ends by a reinforcement strip 38. The reinforcement strip 38 may be of a type known in the art for interconnecting opposing pieces of plastic or other flexible materials to provide a coupling of those materials resistant to forces applied thereto. As shown in FIG. 5, The opposing segments of the foundation ring 18 may be positioned spacedly apart from one other to define an opening 19 into the interior of the greenhouse structure. At one of these openings 19 may define a door opening for accessing the interior of the greenhouse. In some constructions a wall element 22 may be secured to the foundation 18 proximate to the opening 19 to form a door frame for the door opening. A lintel element may be secured to the upper free ends of the two wall elements forming the door frame to interconnect the wall elements and provide a degree of rigidity to the door frame constructions. Wall elements 22 defining such the door frame as well as the door lintel are not shown in FIG. 5 for purposes of clarity.

FIG. 6 illustrates a sectional view of the construction of the wall element 36 in an uninflated condition. As shown, the wall elements are formed of a first sheet of flexible material such as plastic conjoined to a second sheet of flexible material (not shown) having similar dimensions to the first sheet. Prior to the positioning of the two sheets over the greenhouse frame, the second is positioned adjacent to the first sheet such that their respective side, bottom and top edges are positioned immediately adjacent to one another. The two sheets are then conjoined to one another by stitching, heat fusing, ultrasonic fusing or some other connection method along a series of parallel linear connection lines 42 whereby the interconnection of the two sheets forms a single sheet element which defines a plurality of parallelly arranged conduits, each defining a hollow interior. At the top portion of the wall element 36 the individual conduits are sealed. On the bottom portion of the wall element, each of the conduits are accessible through an inlet port (not shown) which permits pressurized air to be introduced into the interior of the conduit whereby the conduits may be inflated as shown in FIG. 7. As further illustrated in FIG. 7, am air pump 40, having an activation switch 42 is connected to the open lower ends of the various conduits 39 through a piping 43. The piping 43 is interconnected to each of the inlet ports of the various conduits 39 to permit pressurized air to be introduced into the respective interior of each conduit 39. With the introduction of pressurized air into the interior into the various conduits 39 the wall element 36 assumes a planar configuration of sufficient rigidity that when the element 39 is positioned upright as shown in FIGS. 6 and 7, the element 36 will remain vertically upright,

FIG. 8 is a partial sectional view of a frame support element 22 of the greenhouse. As shown, the element 22 is formed of a flexible outer material which is formed to define a hollow interior as shown by cutaway 48. Similar to the wall elements 36, the frame elements 22 are filled with pressurized air to render the otherwise flexible structure sufficiently rigid to stand upright and support the overall structure of the greenhouse. As shown each frame element 22 includes a vertically positioned, otherwise upright planar panel 50 spacedly positioned opposite from a vertically positioned planar panel 52 having similar dimensions. Two planar panels 53 are positioned parallel and spacedly opposite from one. Each of the panels 53 is connected along a first upright side edge to a corresponding edge of the panel 50 and along a second upright edge to a corresponding edge of the panel 52. The panels 50, 52 and 53 in their conjoined condition form a quadrilateral cross-sectioned construction which defines a hollow interior, as shown by cutaway 48. The frame element construction defines an access port which permits the introduction of pressurized air into the hollow interior of the construction. With a sufficient introduction of pressurized air, the frame element construction can achieve a sufficient rigidity to stand upright with little if any support.

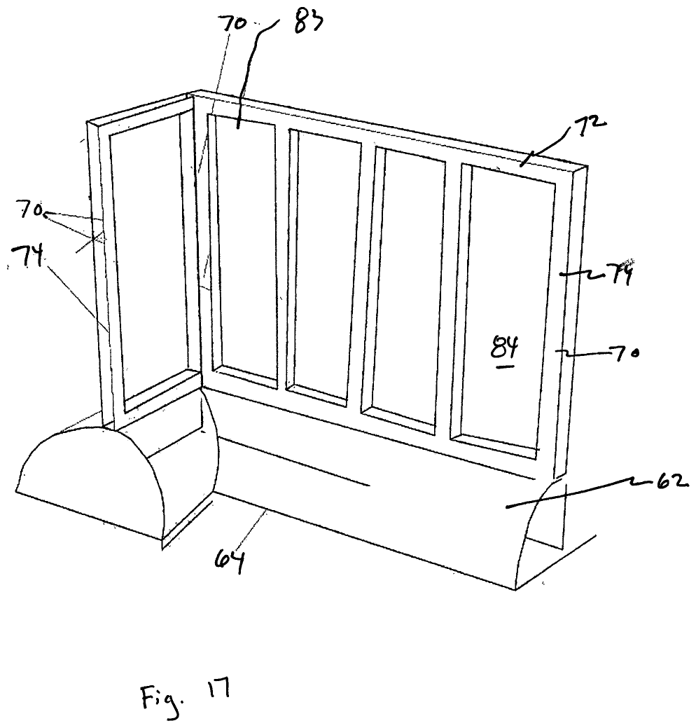

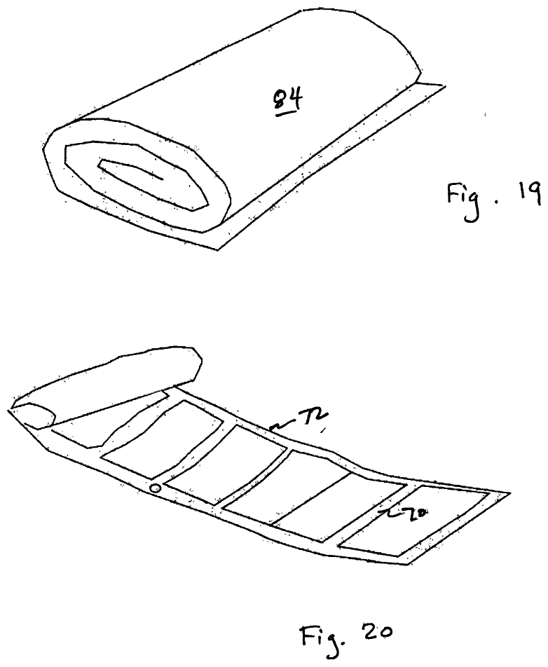

FIGS. 16-21 illustrate a second embodiment of the inflatable greenhouse. With reference to FIG. 16 a greenhouse 60 includes a foundation 62 having a hollow interior dimensioned to receive a quantity of water which serves to provide a ballast for the greenhouse. The foundation may be fitted with an electrical heating mat for heating the water contained with the hollow interior as well as a water pump for pumping water from the ballast to locations within the greenhouse, e.g. for irrigating plants housed within the greenhouse. The interior of the foundation is accessed through a number of valves 81 which are positioned within the upstanding wall of the foundation, Valves 81 are located in various locations throughout the foundation. The foundation has a ground engaging element 64 which is fabricated from a flexible fabric. The element 64 may be positioned directly over the ground underlying the greenhouse and is preferably sufficiently flexible to accommodate irregularities in the ground surface while otherwise supporting the greenhouse in an upright orientation. A series of upright, generally planar walls 68 are positioned atop the foundation 64 and are secured to that foundation. In preferred constructions the walls 68 are secured to the foundation utilizing the bayonet fitting shown in FIG. 9. Alternatively, the walls 68 may be secured to the foundation 62 utilizing adhesives, mechanical couplings, or other fittings known in the art.

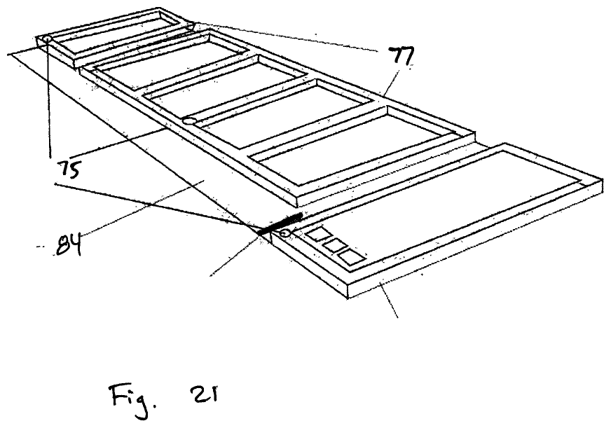

Each of the walls 68 includes a frame element 70 as shown in FIG. 20. The frame 70 includes a plurality of vertically positioned frame elements 74 which are spacedly positioned laterally from one another over the length of the wall. Cross members 72 interconnect with each of the vertical elements 74 on the opposing ends of the vertical elements 74 to form a generally quadrilateral frame-like structure. The various elements of the frame 70 may be fabricated from a drop stitch fabric. The frame elements 72 and 74 of frame 70 each define a hollow interior, which in their combined configuration define a contiguous channel which extends throughout the interior of the frame 70. The interior channel of the frame 70 is adapted to receive a quantity of pressurized air and thereby be inflated through means of an air pump. As shown in FIG. 21 the frame 70 of each wall includes three inflation points or valves 75. At least one of these valves 75 may be a 1 way reversible check valve which permits inflation as well as deflation of the frame element. Subsequent to the introduction of pressurized air into the interior of the drop stitch fabric, the frame 70 achieves a configuration which is sufficiently rigid to retain the wall element in a vertical orientation. As shown in FIG. 21, the frame 70 is secured to a sheet of flexible material 84 by lamination, adhesives or other connective means to form the actual wall of the greenhouse. In preferred constructions the sheet 84 may be formed from a transparent sheet fabricated of Poly vinyl chloride (PVC) plastic or other transparent material which will permit sunlight to enter into the interior of the greenhouse.

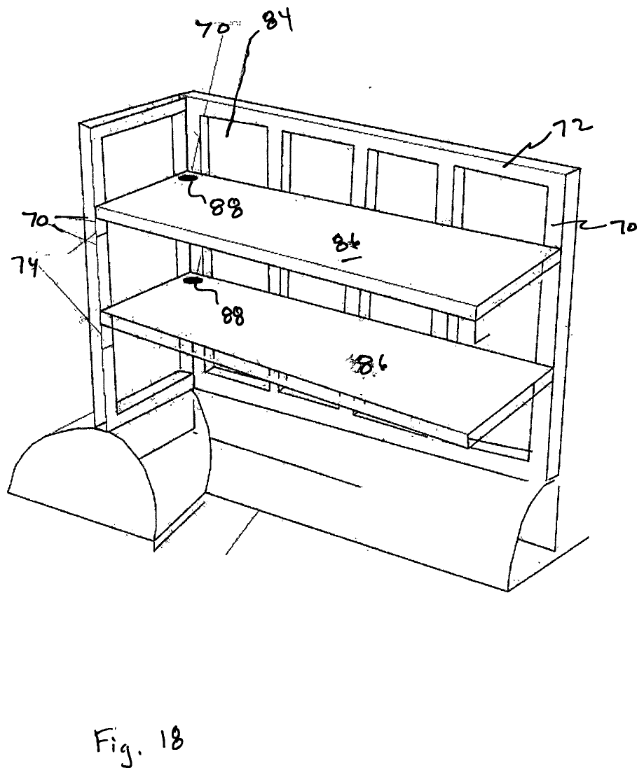

One or more elongate planar shelves 86 may be secured to the frame 70 as shown in FIG. 18 to provide further structural integrity to the walls of the greenhouse. Each shelf may be constructed from drop stitch fabric. Each shelf may also include its own respective inflation valve. The shelves 86 may be secured to the frame 70 through the use of pockets or PVC envelopes defined with the frame 70 or the wall covering 84.

The greenhouse may also be fitted with a reservoir for retaining a supply of plant nutrients.

Each of these shelves 86 may be fitted with an aperture 88 for retaining a water riser. A plumbing system (not shown) may provide means for directing a supply of water from the ballast reservoir in the foundation 60 to the plants placed on the shelves 86 by means of an irrigation system. This plumbing system may also include a water pump adapted for pumping water from the ballast reservoir to the plants positioned on the shelves. In some embodiments each of the shelves may be fitted with a heating pad of a type known in the art to facilitate heating the shelf when the interior of the greenhouse requires additional heat to support plant growth. In one embodiment, these heating pads may be powered by a solar powered energy system of a type known in the art. An optional Arduino/Artificial Intelligence electronic irrigation and climate monitoring computer of a type known in the art may also be installed within the greenhouse to control the operation of the heating pad(s) as well as the irrigation system within the greenhouse.

The invention also contemplates a method for constructing a greenhouse. In this method, a flexible ballast foundation 18 is first laid over an underlying ground surface. As shown in FIG. 3, the foundation 18 may be laid out to define the perimeter of the greenhouse. In the embodiment shown in FIG. 3 the foundation includes two distinct segments which are positioned opposite from one another about a horizontal axis 27. The foundation segments are each filled with water 54 through ports 58 as shown to advantage in FIG. 11. With the water securely placed within the hollow interior of the foundation segments, the foundation segments achieve a sufficient weight to retain the greenhouse in place on the underlying ground surface. As further shown in FIG. 11, the flexible ground engaging portion 59 of the foundation segment is sufficiently flexible to deform and thereby accommodate the presence of stones or other objects positioned on the ground without otherwise unduly effecting the positioning of the remainder of the foundation. It follows that owing to the flexible nature of the bottom portion of the foundation structure, the upper portion of the foundation in its installed condition can still present a generally linear configuration over the length of its top region notwithstanding that the bottom surface of the foundation may be positioned over a generally irregular, i.e. nonplanar, underlying ground surface. The flexible construction of the foundation therefore permits the user considerable latitude in siting the greenhouse without having to be overly concerned about rendering the ground surface which will be positioned under the greenhouse being intensively prepared and leveled prior to the installation of the greenhouse over that surface. When the user desires to disassemble the greenhouse or transport the greenhouse to a different location, the user simply drains the water from the interior of the foundation 18 using outlet port 58A. The plug 59 in outlet port 58A is removed from its threaded engagement with the outlet port 58A thereby opening the port and allowing the water housed within the interior of the foundation to exit through the open port. Subsequently, the plug 59 is reinserted into the outlet port thereby sealing the interior of the foundation and making it ready to receive an further infusion of water when the foundation has been relocated to a new situs.

After the foundation is moved into position and is filled with water, the frame elements 19 are coupled to the foundation 18 to extend vertically upwards therefrom. Each of the foundation segments defines a connection means for forming a secured union with a plurality of upstanding frame elements 22. In the embodiment shown in FIG. 2 this connection means is a slot 56 which is defined by a pair of oppositely positioned flanges 55 formed by the sidewall of the foundation element 18, see FIG. 11. The lower end of each wall element 22 defines a bayonet flange 46 which is inserted into the slot 56 to form a secured union of the wall element 22 and the foundation 18. Each of the flanges 46, being positioned in the hollow interior of a respective slot 56, forms a removeable union of the wall element 22 and the foundation 18.

The frame elements 19 are spacedly positioned along the length of the upper portion of the foundation element 18. The frame elements 19 are arranged to form a generally rectangularly configured frame assembly as shown to advantage in FIG. 3.

Next, the joist elements 24 are installed. One joist element 24 is mounted on a first end to the top end of a respective frame element 19 to extend toward an opposing frame element 19 positioned on the opposite side of the frame assembly. Each joist element may be positioned at an angle 25A from the horizon. The opposing end of each joist is coupled to the free end of an opposing joist element 24 as shown in FIG. 3. In some constructions, a ridge board may be positioned to run along the length of the roof. In this alternative construction, the opposing ends of the joists are coupled to the ridge board to provide a roof frame structure.

The roof may also be fitted with vents with associated vent covers which may be displaced to either open or close the vent openings thereby allowing access into the interior of the greenhouse. The vents provide a means of introducing fresh air into the greenhouse's interior. These vents may be fitted with an actuation mechanism for displacing the vent cover between and open and closed position. In preferred constructions the actuation mechanism is controlled by a computer system which monitors the climate conditions within the greenhouse and thereafter adjusts those conditions through opening or closing the vents as well as controlling the operation of fans positioned within the greenhouse door.

As shown to advantage in FIG. 5, the wall element 36 is next installed. In the preferred method shown in FIG. 4, the wall element 36 is formed of a roll of flexible material, such as plastic, which is first secured along its upright edge to a frame element member 19 along upstanding height of that frame element member 19. The wall element 36 is then rolled laterally over the foundation 18 and along the frame assembly. In some constructions, the wall element 36 may be secured to each wall element 19 against which it comes into abutment, by suitable coupling means known in the art. As shown in FIG. 5 reinforcement elements 38 may be secured to the wall element 36 vertically along the corners of the greenhouse to extend upwards over the height of the wall element 36 in order to provide further reinforcement and rigidity to the greenhouse structure.

With the joists being installed, a gable and fascia board structure 28 may be constructed and positioned on the upper region of the greenhouse frame construction. As shown in FIG. 2, two triangular, pediment shaped structures are positioned parallel to and spacedly from one another are interconnected by a pair of fascia boards 30. As shown the fascia boards 30 are interconnected to the gables at their ends to retain the gables in a fixed relationship to one another. The gables and fascia boards may be constructed of lightweight lumber or alternatively, they may be constructed of the same flexible, translucent inflatable compartment defining material which is utilized to construct the wall element 36. The structure 28 is positioned over the top of the greenhouse frame 19 and secured thereto by conventional coupling structure known in the art.

A roof structure 34 is then installed atop the gable structure 28. The roof structure 34 may be fabricated from the same flexible, translucent, inflatable compartment defining material which is utilized to construct the wall element 36. The roof structure 34 rests on and is supported by the joists 25 and rake 24 which are positioned below the structure 34.

A door 14 may then be installed in the greenhouse structure. In one aspect of the invention, a door frame, formed of two upright frame members and a lintel which extends between the two upright frame members proximate the ends thereof may be constructed utilizing the same flexible, translucent inflatable compartment defining material which was utilized to construct the frame elements 22. The same bayonet flange construction of the wall frame elements 22 may also be fitted on the bottom edge of each upright door frame member. Utilizing the slot 56 in the foundation 18, the door frame may be installed on top of the foundation 18. The door 14 may then be secured to the door frame using a conventional hinge arrangement. The door 14 may also be fabricated from the same flexible, translucent inflatable compartment defining material which was utilized to construct the wall element 36. Alternatively, the door may be constructed from conventional lumber stock. As shown in FIG. 2, the door 14 may be fitted with one of more ventilator fans 20 which may be motorized to provide a source of incoming air into the interior of the greenhouse. In one embodiment, three fans, e.g. PC case fans, are positioned within the door 14. In preferred constructions the door 14 opens inwardly in the interior of the greenhouse. The door 14, as well as the door frame, may be fitted with magnets which interact with one another to form a mechanical sealing mechanism for the door 14 within the door frame.

Once constructed the greenhouse provides a lightweight structure which may be manually moved about over the underlying ground surface. With most, if not all, of the materials utilized. In the construction of the greenhouse being translucent, the interior of the greenhouse is readily accessible to ambient sunlight thereby providing an enhanced growing environment for plants. The greenhouse may also be easily disassembled by deflating some, if not all, of the inflatable compartments which together constitute the wall, frame and roof elements. Furthermore, by draining the foundation of its fluid contents, the weight of the greenhouse is dramatically reduced enabling easy disassembly and transport.

Changes may be made to the aspects and embodiments described in this disclosure without departing from the broad inventive concepts they illustrate. Accordingly, this invention is not limited to the particular embodiments disclosed, but is intended to cover all modifications that are within the scope of the invention as defined by the appended claims.

1. A self-supporting greenhouse structure comprising:
a foundation reservoir having a hollow interior configured to receive and retain a quantity of fluid;
a frame positioned atop said reservoir and coupled thereto;
at least one wall element secured to said frame to substantially enclose an interior region defined by said frame;
a roof, secured to said frame, extending over said frame to substantially cover said interior region.

2. The self-supporting greenhouse structure of claim 1 wherein said frame is formed of a plurality of upstanding frame elements, each frame element being fabricated of a plurality of conjoined, inflated compartments.

3. The self-supporting greenhouse structure of claim 2 wherein said frame elements are spacedly positioned about the foundation reservoir and coupled to the foundation reservoir to extend upwardly therefrom.

4. The self-supporting greenhouse structure of claim 3 wherein each said frame element is fitted with an outwardly extending flange coupled to a lower end thereof.

5. The self-supporting greenhouse structure of claim 4 wherein said foundation defines a laterally extending slot therein dimensioned to receive and retain said flanges of said frame elements and thereby retain said frame elements in an upstanding orientation relative to said foundation.

6. The self-supporting greenhouse structure of claim 5 wherein said foundation includes a flexible bottom surface adapted to deform about objects positioned on a ground surface underlying said self-supporting greenhouse structure wherein said slot remains substantially parallel to the underlying ground surface notwithstanding a presence of said objects.

7. The self-supporting greenhouse structure of claim 6 wherein said foundation is fitted with at least one sealable port for introducing a fluid into said foundation.

8. The self-supporting greenhouse structure of claim 7 wherein said wall element is fabricated from a plurality of conjoined inflatable compartments.

9. The self-supporting greenhouse structure of claim 8 wherein said structure further includes an air pump, coupled to said inflatable wall element compartments for introducing a quantity of pressurized air into said compartments sufficient to support said wall element in a vertically upright orientation.

10. The self-supporting greenhouse structure of claim 9 wherein said wall element is fabricated from a translucent flexible material.

11. The self-supporting greenhouse structure of claim 10 wherein roof element is fabricated from a plurality of interconnected inflatable compartments configured to receive and retain a quantity of pressurized fluid.

12. The self-supporting greenhouse structure of claim 11 wherein said roof element is fabricated from a flexible, translucent material.

13. The self-supporting greenhouse structure of claim 12 wherein said foundation is fabricated from a plurality of independent segments.

14. The self-supporting greenhouse structure of claim 13 wherein said foundation segments are positioned spacedly from one another to define openings within said foundation dimensioned to accommodate a door for ingress into an interior of said greenhouse.

15. The self-supporting greenhouse structure of claim 14 wherein a ventilator fan is installed within said wall element.

16. The self-supporting greenhouse structure of claim 14 wherein a ventilator fan is installed within a door of said greenhouse structure.

17. The self-supporting greenhouse structure of claim 3 further comprising:
a plurality of laterally extending substantially rigid cross elements, each cross element being fabricated from a plurality of inflatable compartments, each said cross element having a pair of opposing ends, each said end being coupled to a respective frame element proximate each said end;
a translucent wall covering fabricated from a flexible fabric defining a multiplicity of inflated compartments, the wall covering being secured to the upstanding frame elements and the cross elements to define a plurality of walls extending upwards from the foundation reservoir; and
a roof element, fabricated of a translucent material, defining a multiplicity of inflated compartments, said roof element being secured to the upright frame elements and the cross elements.

18. The self-supporting greenhouse structure of claim 1 wherein said wall covering defines a door therein configured for providing ingress into an interior of said structure.

19. A self-supporting greenhouse structure comprising:
a flexible foundation reservoir having a hollow interior configured to receive and retain a quantity of fluid;
a plurality of upstanding frame elements, each said frame element being fabricated of a plurality of conjoined, inflatable compartments, said frame elements being spacedly positioned about the foundation reservoir and coupled to said foundation reservoir to extend upwardly therefrom;
a plurality of laterally extending substantially rigid cross elements, each said cross element being fabricated from a plurality of inflatable compartments, each said cross element having a pair of opposing ends, each said end being coupled to a respective frame element proximate each said end;
a translucent wall covering fabricated from a flexible fabric defining a multiplicity of inflatable compartments, the wall covering being secured to the upstanding frame elements and the cross elements to define a plurality of walls extending upwards from the foundation reservoir; and
a roof element, fabricated of a translucent material, defining a multiplicity of inflatable compartments, said roof element being secured to the upright frame elements and the cross elements.

20. The self-supporting greenhouse structure of claim 19 wherein at least one of said inflatable compartments is filled with a quantity of pressurized air.
